(19) United States
(12) Patent Application Publication
(10) Pub. No.: US 2026/0054261 A1
(43) Pub. Date: Feb. 26, 2026

(54) A DIGITAL BURETTE

(71) Applicant: BOROSIL TECHNOLOGIES LIMITED, Mumbai-Maharashtra (IN)

(72) Inventor: Palekudy Sreejith Kumar SUKUMARAN, Kerala (IN)

(73) Assignee: BOROSIL TECHNOLOGIES LIMITED, Mumbai-Maharashtra (IN)

(21) Appl. No.: 18/997,055

(22) PCT Filed: Jul. 18, 2023
(86) PCT No.: PCT/IB2023/057322

§ 371 Date: Jan. 18, 2025

(30) Foreign Application Priority Data
Jul. 18, 2022 (IN) 202221041036

(51) Int. Cl. B01L 3/02

(52) U.S. Cl. CPC B01L 3/0203; B01L 2200/026; B01L 2300/025; B01L 2300/12; B01L 2400/0487

(57) ABSTRACT

A digital burette comprising a housing configured to be mounted on a liquid reservoir, a tube extending from the housing, an input unit provided on the housing, and an actuating device/unit/component/machine/structure configured to communicate with the control unit. The tube fluidly communicates with the liquid reservoir. The input unit receives an input corresponding with a desired volume of the liquid to be dispensed, and generates an input signal. The control unit receives the input signal and generates a processed signal. The actuating device/unit/component/machine/structure is communicatively coupled to the input unit or the control unit to facilitate dispensation of the desired volume of the liquid through the tube based on the received input signal/processed signal.

### FIELD

The present disclosure relates to digital burettes.

### BACKGROUND

The background information herein below relates to the present disclosure but is not necessarily prior art.

A burette is a glass tube with measurements marked on it and a tap at one end, typically used in chemistry for dispensing a precise predetermined amount of a liquid in applications such as titrations. Digitally operating burettes are also known. Conventionally, they include a reciprocating piston incorporated in a graduated glass tube. The piston is manually rotated to enable the tube to receive or dispense the liquid. A sensor is connected to the piston to detect the rotations to calculate the liquid received or dispensed. However, the conventional burette requires continuous monitoring and handling by a skilled operator. The operator has to calculate the dispensed volume of liquid and adjust the rotations of the piston accordingly to derive the quantity of liquid that is to be dispensed. However, this procedure may result in a loss of accuracy. As a result, the conventional digital burette is inept in dispensing a small amount such as 0.01 ml of liquid. Further, both the hands of the operator will be occupied during the process of titration.

As a result, in experiments requiring accuracy and precision, if there is a failure, even of a small scale, the entire procedure has to be performed from scratch. Further, the conventional burettes do not have any provision for storing data related to previous iterations performed by the burette.

There is therefore felt a need for a digital burette that overcomes the aforementioned drawbacks.

### OBJECTS

Some of the objects of the present disclosure, which at least one embodiment herein satisfies, are as follows:

An object of the present disclosure is to provide a digital burette.

Another object of the present disclosure is to provide a digital burette, which can dispense predetermined quantities of a liquid with precision and accuracy.

Yet another object of the present disclosure is to provide a digital burette which significantly reduces failure in procedures requiring accurate dispensation of liquids.

Still another object of the present disclosure is to provide a digital burette which has a provision for storing the data related to previous iterations performed thereby.

Other objects and advantages of the present disclosure will be more apparent from the following description, which is not intended to limit the scope of the present disclosure.

### SUMMARY

The present disclosure envisages a first aspect of a digital burette. The burette comprises a housing configured to be mounted on a liquid reservoir. A tube extends from the housing. An operative first end of the tube is configured to fluidly communicate with the liquid reservoir, and an operative second end of the tube is configured to dispense the liquid. An input unit is provided on the housing. The input unit is configured to receive an input corresponding with a desired volume of the liquid to be dispensed, and is further configured to generate an input signal. A control unit is provided in the housing. The control unit is configured to cooperate with the input unit to receive the input signal. The control unit is further to generate a processed signal based on the received signal. An actuating means is configured to communicate with the control unit to receive the processed signal. The actuating means is further communicatively coupled to the tube to facilitate dispensation of the desired volume of the liquid through the tube.

The present disclosure further envisages a second aspect of a digital burette. The burette comprises a housing configured to be mounted on a liquid reservoir. A tube extends from the housing. An operative first end of the tube is configured to fluidly communicate with the liquid reservoir, and an operative second end of the tube is configured to dispense the liquid. An input unit is provided on the housing. The input unit is configured to receive an input corresponding with a desired volume of the liquid to be dispensed, and is further configured to generate an input signal. An actuating means is communicatively coupled to the input unit to receive the input signal and cooperate with the tube to facilitate dispensation of the desired volume of the liquid through the tube.

### BRIEF DESCRIPTION OF THE ACCOMPANYING DRAWING

A digital burette of the present disclosure of the present disclosure will now be described with the help of the accompanying drawings, in which:

FIG. 1A illustrates an isometric view of the burette of the present disclosure;

FIG. 1B illustrates a block diagram representing a first aspect of the burette of FIG. 1;

FIG. 1C illustrates a block diagram representing a second aspect of the burette of FIG. 1;

FIG. 2 illustrates a cross-sectional view of the burette of FIG. 1, mounted atop a reservoir;

FIG. 3 illustrates an isometric view of the burette, of FIG. 1, in its first operative configuration;

FIG. 4 illustrates an isometric view of the burette, of FIG. 1, in its second operative configuration; and

FIG. 5 illustrates an isometric view of the burette, of FIG. 1, in its unhinged configuration.

### LIST OF REFERENCE NUMERALS

100A, 100B digital burette
1 indicator knob
2 third compartment
3 second compartment
4 compartment
5 adapter
6 liquid reservoir
7 display unit
8 tube
9 delivery nozzle
10 fume lock
11 actuating means
11A roller
12 hinge
13 fume trapping cap
14 housing
15 input unit
16 supporting arm
20 control unit
22 repository
24 processor
32 stepper motor

### DETAILED DESCRIPTION

Embodiments, of the present disclosure, will now be described with reference to the accompanying drawing.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, operations, elements, modules, units and/or components, but do not forbid the presence or addition of one or more other features, operations, elements, components, and/or groups thereof.

When an element is referred to as being “mounted on,” “engaged to,” “connected to,” or “coupled to” another element, it may be directly on, engaged, connected or coupled to the other element. As used herein, the term “and/or” includes any and all combinations of one or more of the associated listed elements.

The terms first, second, third, etc., should not be construed to limit the scope of the present disclosure as the aforementioned terms may be only used to distinguish one element, component, region, layer or section from another component, region, layer or section. Terms such as first, second, third etc., when used herein do not imply a specific sequence or order unless clearly suggested by the present disclosure.

Terms such as “inner,” “outer,” “beneath,” “below,” “lower,” “above,” “upper,” and the like, may be used in the present disclosure to describe relationships between different elements as depicted from the figures.

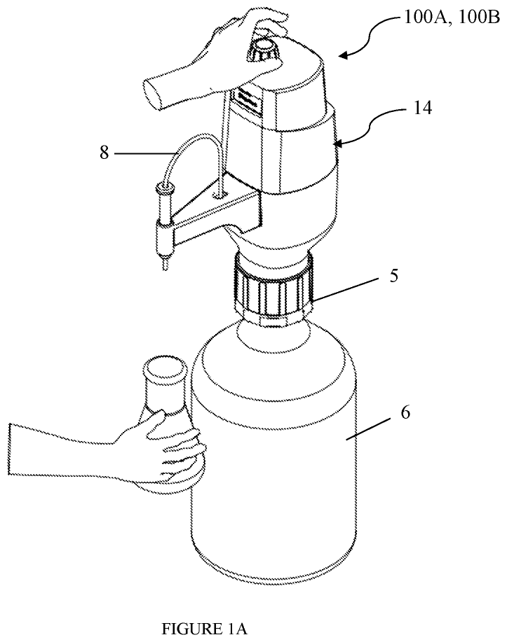

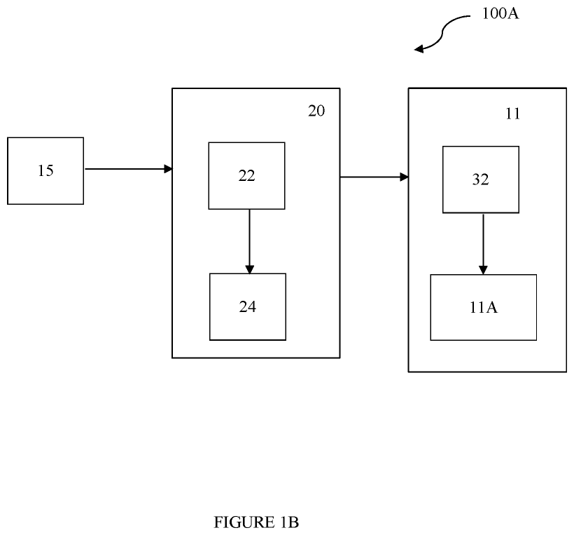

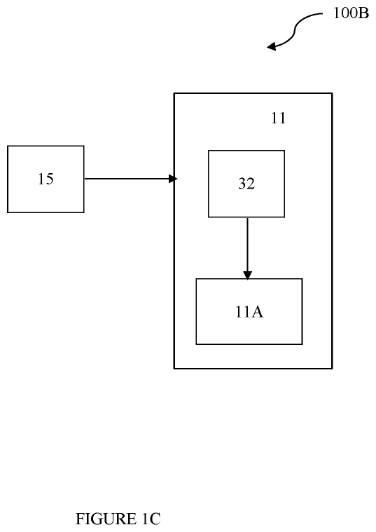

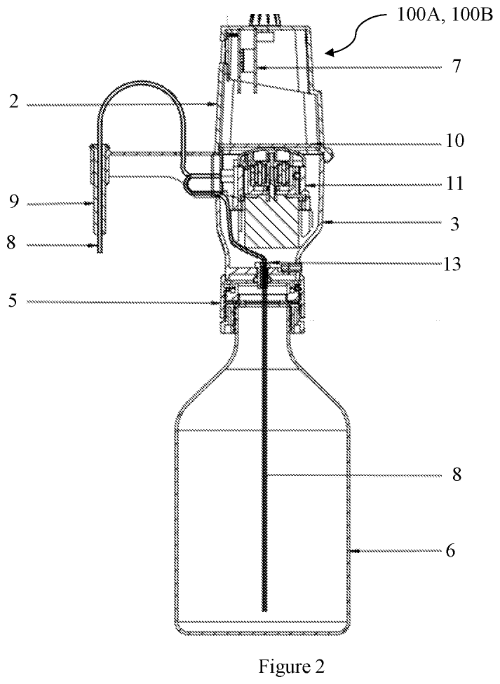

A digital burette (100A, 100B) of the present disclosure will now be described in detail with reference to FIG. 1A through FIG. 5.

In accordance with a first aspect of the present disclosure, as shown in FIG. 1B, the digital burette (100A) comprises a housing (14) configured to be mounted on a liquid reservoir (6) containing a liquid. In an embodiment, the liquid can be but is not limited to acidic or alkaline solutions. The burette (100A) includes a tube (8) extends from the housing (14). An operative first end of the tube (8) is configured to fluidly communicate with the liquid reservoir (6), and an operative second end of the tube (8) is configured to dispense the liquid. An input unit (15) is provided on the housing (14). The input unit (15) is configured to receive an input corresponding with a desired volume of the liquid to be dispensed from an operator, and is further configured to generate an input signal.

The burette (100A) further comprises a control unit (20) provided in the housing (14). The control unit (20) is configured to cooperate with the input unit (15) to receive the input signal. The control unit (20) is further to generate a processed signal based on the received signal. An actuating means (11) is configured to communicate with the control unit (20) to receive the processed signal, respectively. The actuating means (11) is further configured to cooperate with the tube (8) to facilitate dispensation of the desired volume of the liquid through the tube (8) based on the received processed signal.

In an embodiment, the control unit (20) includes a repository (22) configured to store a list of values of input and a list of values of rotational speed corresponding to the list of input values. The control unit (20) additionally includes a processor (24) communicatively coupled to the repository (22). The processor (24) is configured to receive the input signal and convert the input signal to an input value, and is further configured extract the value of rotational speed corresponding to the input value of displacement from the repository (22) to generate the processed signal based on the extracted value.

In an embodiment, the actuating means (11) is a peristaltic pump having a plurality of rollers (11A) configured to periodically abut the tube (8) in an operative configuration thereof to compress and decompress the tube (8) and aspirate the liquid from the reservoir (6) and dispense it. The actuating means (11) further includes a stepper motor (32) configured to be connected to the rollers (11A). The stepper motor (32) is further configured to cooperate with the control unit (20) to receive the processed signal therefrom to facilitate rotation of the rollers (11A) at the extracted rotational speed to ensure a precise dispensation of the liquid in increments, ranging from 0.01 mL to 0.1 mL per dispensation. This fine dispensing capability ensures accurate and controlled delivery of small volumes during titration processes.

In an embodiment, the housing (14) includes a plurality of compartments. A first compartment (4) is defined in an operative lower portion of the housing (14). The first compartment (4) includes a detachable adapter (5) configured to facilitate fastening of the housing (14) on the reservoir (6). In an embodiment, the neck includes a set of adapters (5) of varying diameters configured to be attached on reservoirs of different neck diameters. A second compartment (3) is defined in an operative middle portion of the housing (14), and is configured to receive the actuating means (11) therein. A third compartment (2) is defined in an operative upper portion of the housing (14), and is configured to receive the control unit (20) therein.

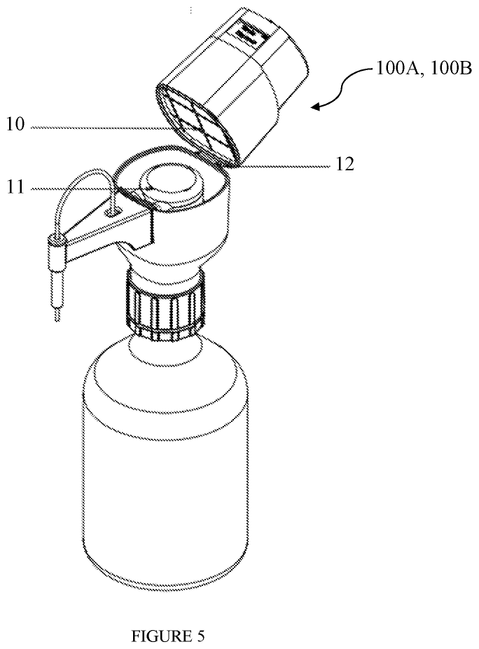

In another embodiment, as shown in FIG. 5, the second compartment (3) is hingeably attached to the third compartment (2). Such type of arrangement is beneficial for an operator to gain access to the actuating means (11) without the need for disassembling the entire housing (14).

In one embodiment, the input unit (15) includes a gauge having a graduated dial (not shown in figures) and an indicator knob (1). The gauge is located on an operative top surface of the housing (14). The indicator is configured to be angularly displaced along the graduations. The knob (1) is configured to be angularly displaced to correspond with the desired volume of the liquid to be dispensed.

In another embodiment, the input unit (15) includes an indicator (not shown in figures) and a set of graduations (not shown in figures) along which the indicator is configured to be displaced to allow the operator to set the desired volume. In an embodiment, the set of graduations herein is a set of linearly configured graduations.

In yet another embodiment, the gauge is an electronic gauge (not shown in figures).

In an embodiment, the repository (22) is configured to record and store previous titration readings to enable operators to track and analyses the progression of their experiments over time. In another embodiment, the control unit (20) is configured to cooperate with a remote device (not shown in figures), thereby allowing real-time data logging, analysis, and automated control, and enhancing the versatility and efficiency of the burette (100A) assembly to providing convenient data management and automation capabilities. Further, the operator does not have to start over an experiment in case of a power failure. In another embodiment, the repository (22) is connected to a display unit (7).

In an embodiment, the burette (100A) includes a display unit (7) located on the third compartment (2). The display unit (7) is communicatively coupled to the input unit (15) to receive the input signal to display the value of the desired volume of liquid.

Since the liquid is confined to the tube (8), it cannot be contaminated by any external contaminants present in the pump, thus ensuring safe handling of the liquid. However, to protect the actuating means (11) and the electronic components from the fumes released by the liquid, in an embodiment, the housing (14) includes a fume lock (10) provided between the first compartment (4) and the second compartment (3). The fume lock (10) acts as a barrier, preventing the ingress of the fumes into the housing (14), more specifically the second compartment (3), thereby maintaining the integrity and functionality of the components. In an embodiment, the housing (14) further includes a fume trapping cap (13) configured to trap fumes emanated from the reservoir.

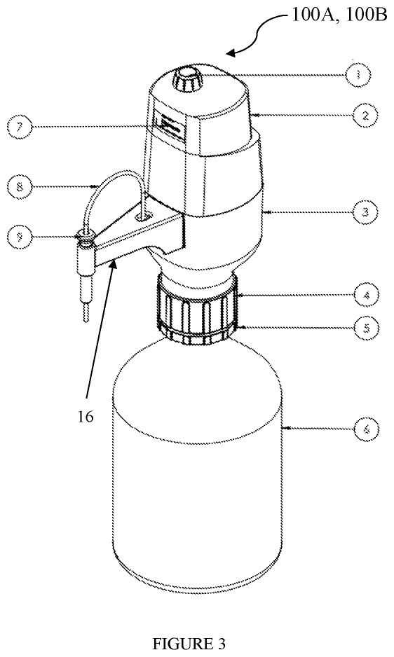

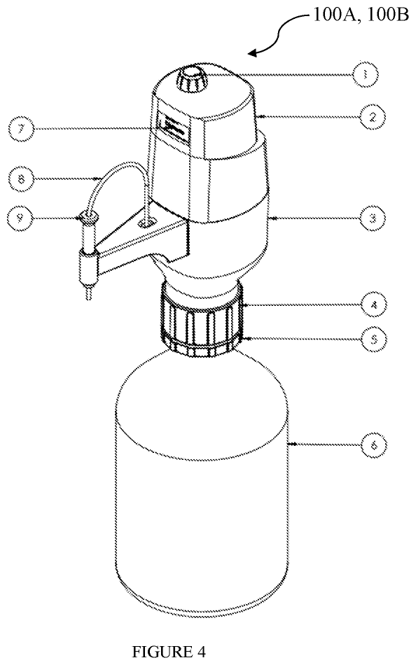

In an embodiment, the housing (14) includes a supporting arm (16) configured thereon. The supporting arm (16) has a delivery nozzle (9) configured to receive the second operative end of the tube (8) therein. The delivery nozzle (9) is extendable to cater to different desired heights of delivery. In a first operative configuration of the burette (100A), as shown in FIG. 3, the nozzle (9) is at its lowest position. In a second operative configuration of the burette (100A), as shown in FIG. 4, the nozzle (9) is at its highest position.

In one embodiment, the first and second operative ends of the tube (8) are telescopic.

In an embodiment, the tube (8) is of inert silicon. In another embodiment, the tube (8) is of polymer.

In an embodiment, the burette (100A) is connected to an external power source (not shown in figures). In another embodiment, the burette (100A) includes a power unit (not shown in figures). The power unit is configured to supply power when the external power source fails to power the burette (100A). In yet another embodiment, the power unit is a 24V battery pack.

In accordance with a second aspect of the present disclosure, the present disclosure further envisages a digital burette (100BB) comprising a housing (14) configured to be mounted on a liquid reservoir (6) containing a liquid. In an embodiment, the liquid can be but is not limited to acidic or alkaline solutions. The burette (100B) includes a tube (8) extends from the housing (14). An operative first end of the tube (8) is configured to fluidly communicate with the liquid reservoir (6), and an operative second end of the tube (8) is configured to dispense the liquid. An input unit (15) is provided on the housing (14). The input unit (15) is configured to receive an input corresponding with a desired volume of the liquid to be dispensed from an operator, and is further configured to generate an input signal.

An actuating means (11) is connected to the input unit (15) to receive the input signal. The actuating means (11) is configured to cooperate with the tube (8) to facilitate dispensation of the desired volume of the liquid through the tube (8) based on the received input signal.

In an embodiment, as shown in FIG. 1C, the actuating means (11) is a peristaltic pump having a plurality of rollers (not shown in figures) configured to periodically abut the tube (8) in an operative configuration thereof to compress and decompress the tube (8) and aspirate the liquid from the reservoir (6) and dispense it. The actuating means (11) includes a stepper motor (32) configured to be connected to the rollers (11A), and further configured to be connected to the input unit (15). The motor (32) is configured to control the speed of rotation of the rollers (11A) with respect to the displacement of the input unit (15) to facilitate dispensation of the desired precise predetermined quantity of the liquid in increments, ranging from 0.01 mL to 0.1 mL per dispensation.

In one embodiment, the input unit (15) includes a gauge having a graduated dial (not shown in figures) and an indicator knob (1). The gauge is located on an operative top surface of the housing (14). The indicator is configured to be angularly displaced along the graduations. The knob (1) is configured to be angularly displaced to correspond with the desired volume of the liquid to be dispensed.

In another embodiment, the input unit (15) includes an indicator (not shown in figures) and a set of graduations (not shown in figures) along which the indicator is configured to be displaced to allow the operator to set the desired volume. In an embodiment, the set of graduations herein is a set of linearly configured graduations.

In yet another embodiment, the gauge is an electronic gauge (not shown in figures).

In an embodiment, the burette includes a database (not shown in figures) configured to record and store previous titration readings to enable operators to track and analyses the progression of their experiments over time. In another embodiment, the control unit (20) is configured to cooperate with a remote device (not shown in figures), thereby allowing real-time data logging, analysis, and automated control, and enhancing the versatility and efficiency of the burette (100B) assembly to providing convenient data management and automation capabilities. Further, the operator does not have to start over an experiment in case of a power failure. In another embodiment, the database is connected to a display unit (7).

In an embodiment, the burette (100B) includes a display unit (7) located on the housing (14). The display unit (7) is communicatively coupled to the input unit (15) to receive the input signal to display the value of the desired volume of liquid.

Since the liquid is confined to the tube (8), it cannot be contaminated by any external contaminants present in the pump, thus ensuring safe handling of the liquid. However, to protect the actuating means (11) and the electronic components from the fumes released by the liquid, in an embodiment, the housing (14) includes a fume lock (10) provided in the housing (14), preferably below the location of the actuating means (11). The fume lock (10) acts as a barrier, preventing the ingress of the fumes into the housing (14), thereby maintaining the integrity and functionality of the components. In an embodiment, the housing (14) further includes a fume trapping cap (13) configured to trap fumes emanated from the reservoir.

In an embodiment, the housing (14) includes a supporting arm (16) configured thereon. The supporting arm (16) has a delivery nozzle (9) configured to receive the second operative end of the tube (8) therein. The delivery nozzle (9) is extendable to cater to different desired heights of delivery. In a first operative configuration of the burette (100B), as shown in FIG. 3, the nozzle (9) is at its lowest position. In a second operative configuration of the burette (100B), as shown in FIG. 4, the nozzle (9) is at its highest position.

In one embodiment, the first and second operative ends of the tube (8) are telescopic.

In an embodiment, the tube (8) is of inert silicon. In another embodiment, the tube (8) is of polymer.

In an embodiment, the burette (100B) is connected to an external power source (not shown in figures). In another embodiment, the burette (100B) includes a power unit (not shown in figures). The power unit is configured to supply power when the external power source fails to power the burette (100B). In yet another embodiment, the power unit is a 24V battery pack.

The digital burette (100A, 100B) does not need the operator to use it with both hands. The operator needs to use only one hand to set the graduations. Thus, the burette (100A, 100B) is a convenient and simple solution which allows the free hand of the operator. Further, there is no more any necessity of refilling the burette (100A, 100B) manually.

The digital burette (100A, 100B) can be used in applications including but not limited to pharmaceutical industries, healthcare industries, food and beverage industries, agriculture industries, environmental monitoring applications, academic and research applications, life sciences and biotechnological industries, and applications pertaining to natural resources.

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

### Technical Advancements

The present disclosure described hereinabove has several technical advantages including, but not limited to, the realization of a digital burette, which:
can dispense predetermined quantities of a liquid with precision and accuracy;
significantly reduces failure in procedures requiring accurate dispensation of liquids;
which is convenient and simple to use without the need for the operator to be occupied therewith at all times; and
has a provision for storing the data related to previous iterations performed by the burette.

The foregoing disclosure has been described with reference to the accompanying embodiments which do not limit the scope and ambit of the disclosure. The description provided is purely by way of example and illustration.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Any discussion of materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A digital burette (100A) comprising:
a housing (14) configured to be mounted on a liquid reservoir (6);
a tube (8) extending from said housing (14), wherein an operative first end of said tube (8) is configured to fluidly communicate with said liquid reservoir (6), and an operative second end of said tube (8) is configured to dispense the liquid;
an input unit (15) provided on said housing (14), said input unit (15) configured to receive an input corresponding with a desired volume of the liquid to be dispensed, and further configured to generate an input signal;
a control unit (20) provided in said housing (14), said control unit (20) configured to cooperate with said input unit (15) to receive said input signal, said control unit (20) further to generate a processed signal based on said received signal; and
an actuating means (11) connected with said control unit (20) to receive said processed signal, said actuating means (11) further configured to cooperate with said tube (8) to facilitate dispensation of the desired volume of the liquid through said tube (8).

2. The digital burette (100A) as claimed in claim 1, wherein said control unit (20) includes:
a repository (22) configured to store a list of values of input and a list of values of rotational speed corresponding to said list of input values; and
a processor (24) communicatively coupled to said repository (22), said processor (24) configured to receive said input signal and convert said input signal to an value, and further configured extract the value of rotational speed corresponding to said input value of displacement from said repository (22) to generate said processed signal based on said extracted value.

3. The digital burette (100A) as claimed in claim 2, wherein said actuating means (11) is a peristaltic pump having a plurality of rollers (11A) configured to periodically abut said tube (8) in an operative configuration thereof to compress and decompress said tube (8) and aspirate the liquid from the reservoir (6) and dispense it.

4. The digital burette (100A) as claimed in claim 3, wherein said actuating means (11) includes a stepper motor (32) configured to be connected to said rollers (11A), and further configured to cooperate with said control unit (20) to receive said processed signal therefrom to facilitate rotation of said rollers (11A) at said extracted rotational speed to ensure precise dispensation of the liquid in increments, ranging from 0.01 mL to 0.1 mL per dispensation.

5. The digital burette (100A) as claimed in claim 1, wherein said housing (14) includes a plurality of compartments,
wherein a first compartment (4) is defined in an operative lower portion of said housing (14), and includes a detachable adapter (5) configured to facilitate fastening of said housing (14) on the reservoir (6);
wherein a second compartment (3) is defined in an operative middle portion of said housing (14), and is configured to receive said actuating means (11) therein; and
wherein a third compartment (2) is defined in an operative upper portion of said housing (14), and is configured to receive said control unit (20) therein.

6. The digital burette (100A) as claimed in claim 4, wherein said second compartment (3) is hingeably attached to said third compartment (2).

7. The digital burette (100A) as claimed in claim 4, wherein said housing (14) includes a fume lock (10) provided between said first compartment (4) and said second compartment (3), said fume lock (10) configured to prevent ingress of fumes into said second compartment (3).

8. The digital burette (100A) as claimed in claim 1, wherein said input unit (15) includes a gauge having a graduated dial and an indicator knob (1), said gauge being configured to be located on an operative top surface of said housing (14), wherein said indicator knob (1) is configured to be angularly displaced along the graduations configured to correspond with the desired volume of the liquid to be dispensed.

9. The digital burette (100A) as claimed in claim 1, which includes a display unit (7) located on said third compartment (2), said display unit (7) being communicatively coupled to said input unit (15) to receive said input signal to display the value of the desired volume of liquid.

10. The digital burette (100A) as claimed in claim 1, wherein said housing (14) includes a supporting arm (16) configured thereon, said supporting arm having a delivery nozzle (9) configured to receive said second operative end of said tube (8) therein, said delivery nozzle (9) being extendable to cater to different desired heights.

11. The digital burette (100A) as claimed in claim 1, wherein said first and second operative ends of said tube (8) are telescopic.

12. The digital burette (100A) as claimed in claim 1, wherein said tube (8) is of inert silicon.

13. The digital burette (100A) as claimed in claim 1, wherein said tube (8) is of polymer.

14. A digital burette (100B) comprising:
a housing (14) configured to be mounted on a liquid reservoir (6);
a tube (8) extending from said housing (14), wherein an operative first end of said tube (8) is configured to fluidly communicate with said liquid reservoir (6), and an operative second end of said tube (8) is configured to dispense the liquid;
an input unit (15) provided on said housing (14), said input unit (15) configured to receive an input corresponding with a desired volume of the liquid to be dispensed, and further configured to generate an input signal; and
an actuating means (11) connected to said input unit (15), said actuating means (11) configured to receive said input signal, said actuating means (11) further configured to cooperate with said tube (8) to facilitate dispensation of the desired volume of the liquid through said tube (8) based on said input signal.

15. The digital burette (100B) as claimed in claim 14, wherein said actuating means (11) is a peristaltic pump having a plurality of rollers (11A) configured to periodically abut said tube (8) in an operative configuration thereof to compress and decompress said tube (8) and aspirate the liquid from the reservoir (6) and dispense it.

16. The digital burette (100B) as claimed in claim 15, wherein said actuating means (11) includes a stepper motor (32) configured to be connected to said rollers (11A), and further configured to be connected to said input unit (15), said motor (32) being configured to control the speed of rotation of said rollers (11A) with respect to the displacement of said input unit (15) to facilitate dispensation of the desired precise predetermined quantity of the liquid in increments, ranging from 0.01 mL to 0.1 mL per dispensation.

17. The digital burette (100B) as claimed in claim 14, wherein said input unit (15) includes a gauge having a graduated dial and an indicator knob (1), said gauge being configured to be located on an operative top surface of said housing (14), wherein said indicator knob (1) is configured to be angularly displaced along the graduations configured to correspond with the desired volume of the liquid to be dispensed.

18. The digital burette (100B) as claimed in claim 14, which includes a display unit (7) located on said housing (14), said display unit (7) being communicatively coupled to said input unit (15) to receive said input signal to display the value of the desired volume of liquid.

19. The digital burette (100B) as claimed in claim 14, wherein said housing (14) includes a fume lock (10) provided in said housing (14), said fume lock (10) configured to prevent ingress of fumes into said housing (14).

20. The digital burette (100B) as claimed in claim 14, wherein said housing (14) includes a supporting arm (16) configured thereon, said supporting arm having a delivery nozzle (9) configured to receive said second operative end of said tube (8) therein, said delivery nozzle (9) being extendable to cater to different desired heights.

21. The digital burette (100B) as claimed in claim 14, wherein said first and second operative ends of said tube (8) are telescopic.

22. The digital burette (100B) as claimed in claim 14, wherein said tube (8) is of inert silicon.

23. The digital burette (100B) as claimed in claim 14, wherein said tube (8) is of polymer.
